(19) United States
(12) Patent Application Publication
(10) Pub. No.: US 2008/0282187 A1
(43) Pub. Date: Nov. 13, 2008

(54) Visualization of citation and coauthor traversal

(75) Inventors: Jon Michael Buschman, Seattle, WA (US); Yue Liu, Issaquah, WA (US); Bongshin Lee, Issaquah, WA (US); Mary Czerwinski, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/800,956

(22) Filed: May 7, 2007

(51) Int. Cl. G06F 3/048

(52) U.S. Cl. 715/784; 715/781

(57) ABSTRACT

When searching for academic or research publications, a user can be presented, not only with a linear listing of publications that may be relevant to the user's search terms, but the user can also be presented with a citation map representing a visual presentation of the interrelationships between a selected publication and the publications which cite to it, and the publications which are cited to by the selected publication. An initial amount of information associated with such a citation map can be provided concurrently with each search result. Additional information can be provided, and presented to the user, through user interaction with the visualization derived from the already provided metadata.

### BACKGROUND

Academic and research publications, like most other printed material, were traditionally stored and indexed based on their title, author or general field of relevance or study. However, academic and research publications also provided an internal linking system by way of the cited references within the publications. Specifically, each publication cited to, or otherwise referenced, relevant publications that preceded it, thereby identifying the source of more detailed information about a specific topic that the current publication relied on, or sought to build upon or provide greater insight into. Seminal publications in any field of study could be identified by their frequent citation in subsequent publications. Additionally, the development or evolution of any field of study could be observed by iteratively reviewing the cited references.

As academic and research publications became stored in computer-readable textual formats, computer-implemented searching mechanisms became the preferred mechanism by which relevant publications could be identified. While some research publications may be stored in a proprietary, or otherwise not easily accessible computer-readable format, the vast majority of such publications can be accessed, either directly or indirectly, through the World Wide Web (WWW). Consequently, web-centric searching technologies and mechanisms have been applied to academic and research publications.

Traditionally, a web-centric searching mechanism, commonly referred to as a “search engine,” comprises an user entry mechanism by which a user can enter one or more words, characters, or phrases, known as the “search string” or the user's “query.” The search string represents the words, characters or phrases that the user wishes to find in one or more publications. The search engine will then reference a database comprising the content of a myriad of publications, seeking to identify one or more publications that contain the search string that the user entered. More advanced search engines can also apply common linguistic permutations to the words or phrases that the user is searching for in an effort to provide a more complete result. Thus, if the user searched for the word “computers,” the search engine could also search for the singular form “computer,” or even the verb form “computing,” so as not to exclude, for example, publications referencing a single “computer” but not multiple “computers.”

To generate a database which can be searched for the user's search string, search engines commonly employ automated processes known as “crawlers” to read information from one or more publications. The search engine can then store the information in an optimized format to reduce the amount of storage space used, and to improve searching efficiency. The search results that are generated by a search engine in response to a user's entry of a search string are generally presented to the user in the form of a series of links to the publication determined relevant to the user's query. Clicking on any of the links will enable the user to view the identified publication.

### SUMMARY

To benefit from the referencing that is inherently performed by authors of academic or research publications, a search engine can not only provide a listing of publications relevant to, or containing, the search string, but can also provide a visual representation of the referencing associated with those publications. In one embodiment, such a visual representation can comprise a temporal indication illustrating previous publications cited by a selected publication and subsequent publications which cite to the selected publication. In a further embodiment, the visual representation can comprise a map in which referencing connections between publications can be illustrated as connecting lines between the publications. Such a map can illustrate relationships between two or more publications through common citations, even though the two or more publications may not reference each other directly. Additionally, techniques common to computer-implemented maps can be utilized, such as scrolling and zooming.

A search engine directed to the searching of academic or research publications can, in one embodiment, implement a multi-faceted user interface. A primary facet can provide for the presentation of the search results as a list of publications that comprise the search terms or are otherwise relevant to them. The selection of a publication from this list of publications can trigger the presentation of additional information regarding that publication in a subsidiary facet of the user interface. Such additional information can comprise a visual representation of the referencing associated with the selected publication, including an indication of publications cited by the selected publication and publications which cite to the selected publication. In a further embodiment, the primary facet can remain unchanged while the information presented in a subsidiary facet responds to user interaction. For example, the search results presented as a list of publications can remain unchanged while a user can interact with the visual representation of the referencing associated with a selected publication. Such user interaction can comprise selecting other publications from the visual representation, thereby causing the visual representation to display referencing associated, not with the initial publication, but with the subsequently selected publication.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of an exemplary system that provides context for the described functionality;

FIG. 2 is a block diagram of an exemplary computing device;

FIG. 3 is an example of a rendered web page providing search results;

FIG. 4 is another example of a rendered web page providing search results;

FIG. 5 is another example of a rendered web page providing search results;

FIG. 6 is another example of a rendered web page providing search results; and

FIG. 7 is a flowchart illustrating an exemplary process for providing information associated with the display of search results.

### DETAILED DESCRIPTION

The following description relates to providing a visual representation of the referencing associated with an academic or research publication returned by a search engine as being relevant to a search query entered by a user. In one embodiment, a multi-faceted user interface can be utilized to present search results to a user in a primary facet, and to further present, in a secondary facet, an interactive visual representation of the referencing associated with a publication selected from the search results. By interacting with the visual representation of the referencing associated with the selected publication, the user can select cited, or citing, publications, and, by browsing around can observe the interrelationships of multiple publications within a particular field of study or research.

The techniques described herein focus on the display of search results in a multi-faceted manner and the provision of data to enable such a display. In one embodiment, each search result can be transmitted to a displaying computing device with a sufficient amount of metadata associated with the search result to enable the presentation of additional information regarding that search result without initiating further communication with the computing device hosting the search engine. Such metadata can comprise at least an indication of the publications cited by the search result and the publications citing to the search result. In a further embodiment, additional information regarding either the citing, or cited to, publications, can be obtained on a per-request basis.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

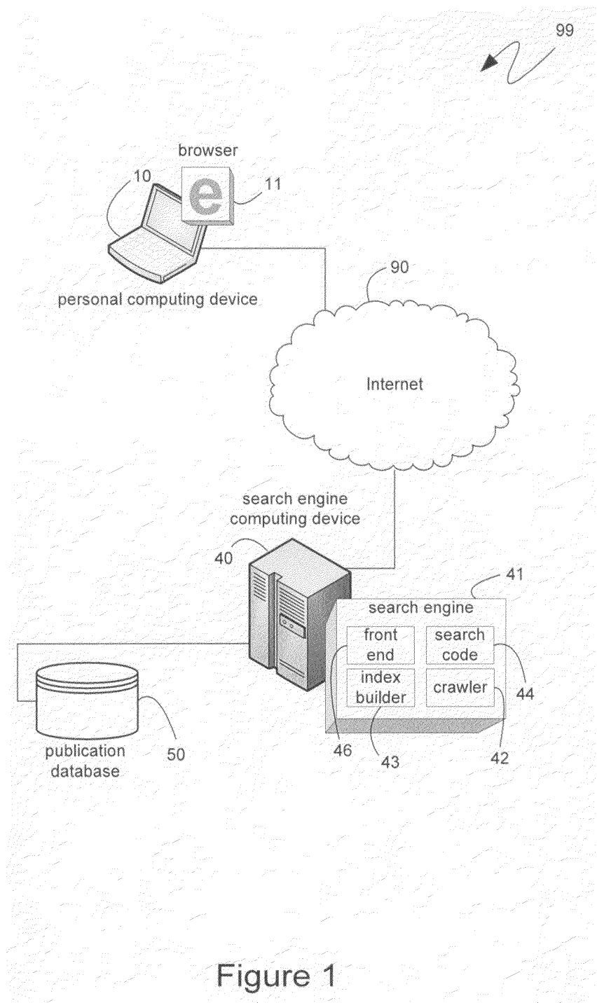

With reference to FIG. 1, an exemplary system 99 is illustrated, providing context for the descriptions below. The exemplary system 99 can be part of the Internet 90, as illustrated, though the reference to the Internet is strictly an example and is not intended to limit the descriptions to Internet protocols, such as the Transmission Control Protocol (TCP), the Internet Protocol (IP), or any other Internet-specific technology. Exemplary system 99 includes a personal computing device 10, executing a browser 11, and a search engine computing device 40, which can host a search engine 41. The search engine 41 can comprise a number of interrelated components, including one or more crawlers, such as crawler 42, an index builder 43, search code 44 and a front end 46. A crawler, such as crawler 42, can obtain information from a publication, whether stored locally to the search engine computing device 40, or elsewhere on the Internet 90, and provide such information to the index builder 43, or similar component, to create or update an appropriately structured database, such as the publication database 50. In one embodiment, the index builder 43 aggregates the information from multiple publications into storage elements that are stored in the database 50. The aggregated information can include, not only the textual information of the publications themselves, but also metadata, including, for example, the authors of the publication, the institute or university hosting the research described in the publication, the journal, magazine or conference proceeding in which the information was published, and the other publications cited by the publication.

A user, such as a user of web browser 11 on personal computing device 10, can provide a search string to the search engine 41 through the front end 46, which can comprise an initial web page, or other appropriate interface, enabling a user to enter search terms, and subsequent web pages or other user interfaces that can be generated, listing some or all of the results. Upon receiving a search string, the search code 44 can search through the database 50 and identify the publications that are relevant to the search string. In addition, the search code 44 can also rank the identified publications such that those publications deemed most relevant would be the first to be presented to the user. The user can subsequently select an alternative ranking mechanism, such as a chronological or alphabetical ranking.

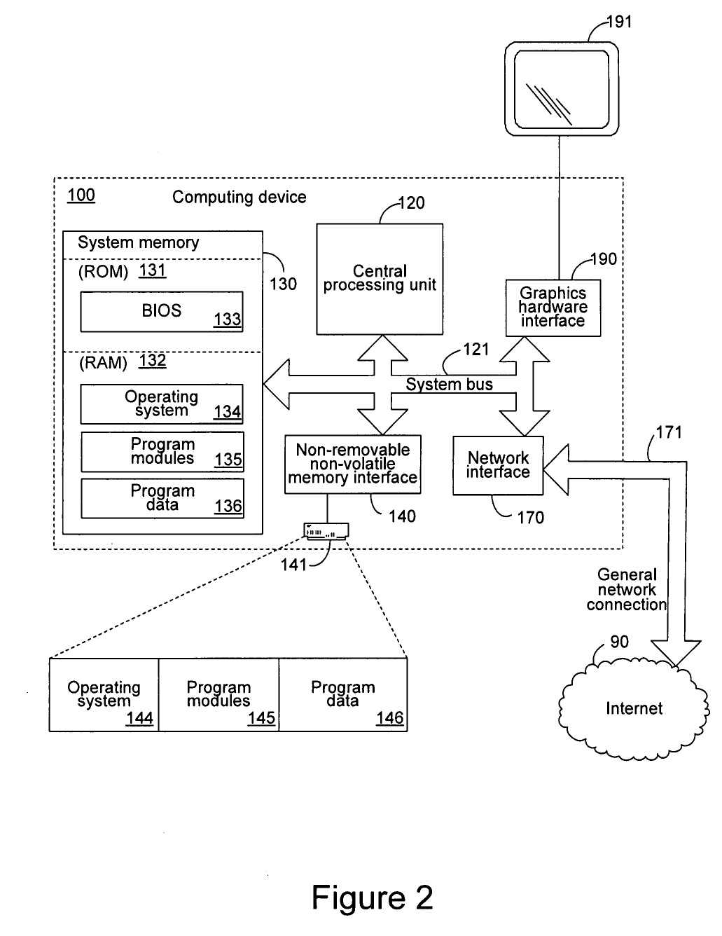

Turning to FIG. 2, an exemplary computing device 100 is illustrated. Either of the computing devices of system 99 shown in FIG. 1 can be of the form of the exemplary computing device 100, including the personal computing device 10 and the search engine computing device 40.

The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include the Peripheral Component Interconnect (PCI) bus and various higher speed versions thereof, the Industry Standard Architecture (ISA) bus and Enhanced ISA (EISA) bus, the Micro Channel Architecture (MCA) bus, and the Video Electronics Standards Associate (VESA) bus. The computing device 100 can optionally include graphics hardware, including, but not limited to, a graphics hardware interface 190 and a display device 191.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, other program modules 135, and program data 136.

The computing device 100 may also include other removable/non-removable, volatile/nonvolatile computer storage media. By way of example only, FIG. 2 illustrates a hard disk drive 141 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers hereto illustrate that, at a minimum, they are different copies.

Of relevance to the descriptions below, the computing device 100 may operate in a networked environment using logical connections to one or more remote computers. For simplicity of illustration, and in conformance with the exemplary system 99 of FIG. 1, the computing device 100 is shown in FIG. 2 to be connected to the Internet 90. However, the computing device 100 is not limited to any particular network or networking protocols. The logical connection depicted in FIG. 2 is a general network connection 171 that can be a local area network (LAN), a wide area network (WAN) or other networks. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

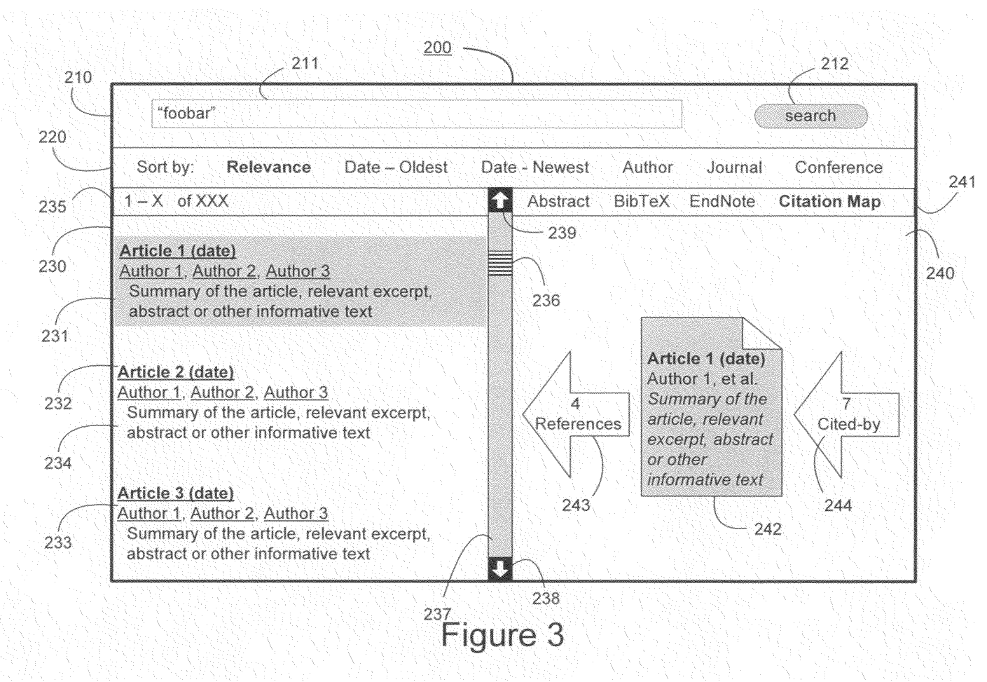

As indicated previously, network communication between a user and the search engine 41 occurs via pages generated by the front end 46 and displayed for the user by web browser 11. Turning to FIG. 3, an exemplary web page display 200 comprising search results is shown. The exemplary web page display 200 is visually subdivided into multiple segments, including a search area 210 for entering search strings, a sorting selection area 220 for selecting a sorting mechanism to be applied to the search results, a results area 230 for displaying the results of a search and a details area 240 for displaying additional information regarding a publication selected in results area 230. Included in the search area 210 can be an entry field 211 for receiving the search string from the user, and a search initiation button 212 to enable the user to request a search of the entered string. The sorting selection area 220 can comprise various sorting mechanisms which can be applied by the search engine to the results displayed in the results area 230. For example, the exemplary web page display 200 of FIG. 3 illustrates six different sorting mechanisms, including sorting based on the determined relevance of the publication to the user's search string, sorting based on chronology, sorting based on author or journal names, or sorting based on the conference at which the publication was presented. As shown, the selected sorting mechanism can be indicated via a visual reference, such as bold text.

The results area 230 can comprise a listing of results and can be prefaced by a guide 235, which can comprise an indication of the currently displayed range of search results and the total number of search results. In one embodiment, the scrolling through the search results, such as by dragging the indicator 236 along the scroll bar 237, or by selecting arrows 238 or 239, can result in the automatic updating of the currently displayed range of search results as indicated by the guide 235 The search results can be presented in a variety of formatting styles. One exemplary style is illustrated by the exemplary web page display 200 of FIG. 3. Specifically, each search result can comprise a title 232 of the publication identified by the search results, a listing of the authors 233 of the identified publication, and an abstract, summary, relevant excerpt, or other informative text 234. A selected search result 231 can be indicated via shading, such as that shown in FIG. 3. Additionally, in a web environment, hyperlinks can be provided as part of the search results. For example, the title 232 can provide a link to the publication itself, which can be viewed or downloaded by the user through the web browser 11. Similarly, each author 233 can provide a link to a search, by the search engine 41, of other publications by that author.

The selection of a search result, such as selection 231, can result in the presentation of additional material in the details area 240. As with the results area 230, the details area 240 can have a preface, in this case in the form of details selection 241 providing for the selection of a particular category of detail to be displayed. In the exemplary web page display 200 of FIG. 3, the options listed in the details selection 241 enable a user to request additional details in the form of the complete abstract of the selected publication 231, the BibTeX entry of the selected publication, the EndNotes of the selection publication, or a citation map originating at the selected publication. As with the sorting selection area 220, the selected details selection 241 can be indicated via a visual reference, such as bold text.

In one embodiment, the selection of the citation map originating at the selection publication can result in the display, within the details area 240, of an iconic representation of the selected publication 231, together with visual indicators providing the quantity of publications that were cited by the selected publication 231 and providing the quantity of publications that cite to the selected publication. Thus, as shown in the exemplary web page display 200 of FIG. 3, the details area 240 can comprise a publication icon 242, and indicators 243 and 244.

The data presented via publication icon 242 and indicators 243 and 244 can, in one embodiment, have been provided by the search engine 41 to the web browser 11 when the search results were provided. Consequently, user selection of any of the results displayed in results area 230 can result in the display of a publication icon and indicators without requiring further communication with the search engine computing device 40, thereby enabling more responsive presentation and user interaction. In an alternative embodiment, however, the display of the publication icon 242 and indicators 243 and 244 can require additional communication with the search engine computing device 40, thereby enabling the search engine 41 to transmit a smaller set of data initially, and providing for a more responsive presentation of the search results themselves.

The publication icon 242 and indicators 243 and 244 represent only an example of a contemplated initial presentation of a citation map associated with a search result selected in the results area 230. In some embodiments, especially when initial citation map data is to be provided by the search engine 41 with the search results, there can be advantages to limiting the quantity of citation map data transmitted. Consequently, the initial presentation of the relevant citation map can visually present a minimum of data. FIG. 3 illustrates one example, though other approaches are equally applicable to the present descriptions. For example, a more broad citation map image can be presented, with areas beyond the information provided simply demarcated with shading. Alternatively, details area 240 can comprise icons for each of the publications indicated by indicators 243 and 244, though such icons could comprise no information beyond the mere existence of the publication.

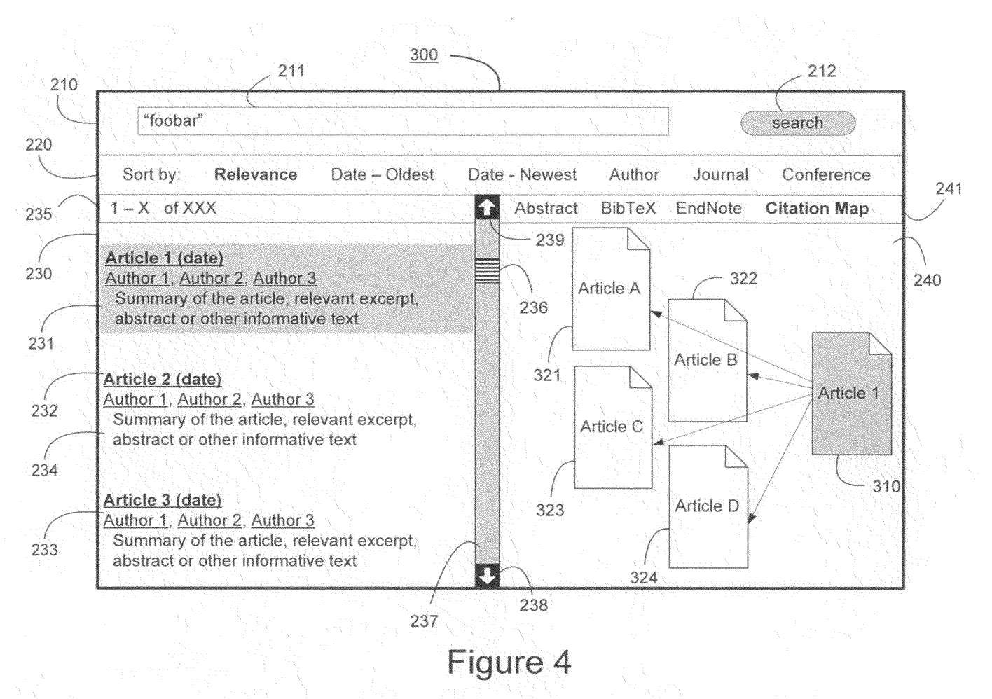

Irrespective of the precise visual presentation format of an initial citation map details area 240 associated with a search result selected in the results area 230, subsequent user interaction with the initial citation map can be provided, enabling the user to see more of the relevant citation map. For example, in the exemplary visual presentation illustrated in FIG. 3, the indicators 243 and 244 can be responsive to user interaction. Thus, if the user were to, for example, select indicator 243, a responsive visual presentation, such as the one illustrated in FIG. 4, can be provided.

The web page display 300 of FIG. 4 illustrates an exemplary response to the selection of indicator 243 of FIG. 3. As such, many of the same elements of the web page display 200 of FIG. 3 are likewise present in the web page display 300 of FIG. 4 and, to the extent that such elements are completely unchanged, they are referenced by the same numerical identifiers as in FIG. 3, and need not be discussed further herein. Additionally, in one embodiment, user interaction with the initial citation map presented in details area 240 of FIG. 3 need not affect the presentation of the search results in the results area 230. Specifically, as illustrated in the web page display 300 of FIG. 4, the search results presented in results area 230 can remain the same, and they can further even remain organized in the same manner as previously selected via sorting selection area 220.

The exemplary response illustrated in FIG. 4, to the selection of indicator 243 of FIG. 3, comprises a reduction in the size, and amount of information presented in, the icon 310 of the publication that corresponds to the selected search result. Such a reduction can provide for the display of additional icons 321, 322, 323 and 324 representing publications which were cited by the publication represented by icon 310. To correlate icon 310 to the publication selected in the results area 230, both can be shaded, such as in the manner shown in FIG. 4, or they can both be otherwise similarly distinguished. Additionally, to indicate the citation, by the publication represented by icon 310, of the publications represented by icons 321, 322, 323 and 324, arrows can be shown, in the details area 240, originating from the icon 310 and pointing to icons 321, 322, 323 and 324.

In an alternative embodiment, icons 321, 322, 323 and 324 can be visually oriented to present additional information, such as their relative publication dates in a chronological order, with, for example, the oldest publications being shown to the far left, and more recent publications being shown closer to the icon 310 on the right. Similarly, information that may be difficult to display on smaller publications icons, such as icon 310, can be displayed through a temporary graphical element in response to user action with respect to the icons. Thus, for example, while the icons 310, 321, 322, 323 and 324, displayed in the details area 240 of FIG. 4, can all comprise at least some of the title of their respective publications, they may be too small to reasonably include additional information. Such additional information, including, for example, the authors or the date of the publication, can be provided in a temporary “balloon” notification when the user hovers their cursor over one of the icons, or, alternatively, such additional information can be provided through a pop-up window in response to the user clicking, or otherwise selecting, one of the icons.

By illustrating the publications cited by the selected search result, the details area 240 of FIG. 4 comprises a portion of a citation map that the user can navigate around in and explore, much in the same way that a user could navigate and explore a more traditional map. For example, in one embodiment, if the number of publications cited to by the selected search result exceed the display area provided by the browser 11, the visual representation of those publications can extend beyond the immediately displayable area of details area 240, and the user can navigate either via scrolling mechanisms, such as the scroll bar 237, or by simply clicking and dragging within the details area 240. In an alternative embodiment, zooming mechanisms can be utilized to display large numbers of related publications within a small area. For example, all of the publications cited to by the selected search result can be displayed within an instantaneously visible area of the details area 240, though such a visualization could require very small icons that may not be able to comprise even the publication title. A zoom mechanism could, therefore, be provided to enable a user to enlarge the icons, displaying only a selected portion of the related publications, though the displayed icons could now be sufficiently sized to comprise informational content.

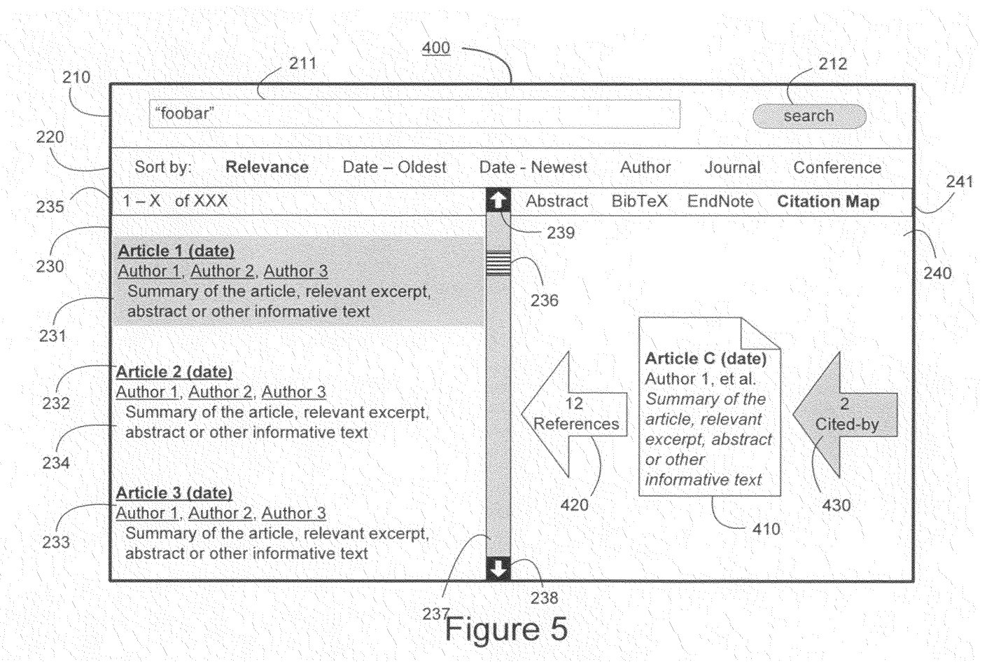

To enable a user to explore interrelationships between publications, the selection of one of the icons 321, 322, 323 or 324, representing the cited to publications, can, in one embodiment, provide further information regarding publications related to the selected publication. For example, if the user were to select, such as by double-clicking, or otherwise focusing user input upon, icon 323, the display of the details area 240 can respond to such a selection on the part of the user by displaying further information regarding the publications associated with the publication referenced by icon 323. FIG. 5 illustrates an exemplary web page display 400 showing one contemplated response. As with FIG. 4, the exemplary web page display 400 of FIG. 5 comprises elements in common with the exemplary web page display 300 of FIG. 4 and the exemplary web page display 200 of FIG. 3. To the extent that such elements remain unchanged, they are referenced within FIG. 5 with the same reference numerals as in FIGS. 3 and 4. Thus, as can be seen, the results area 230, in the illustrated embodiment, can remain unchanged despite the selection of a different publication in the details area 240.

The selected publication can be displayed in the details area 240 in a manner similar to that described above with respect to the initial display, in the details area 240, of the selected search result from the results area 230. Specifically, a visual element, such as icon 410, can provide information regarding the publication itself, such as some or all of the title of the publication, its authors, the date on which it was published or an abstract, summary, or other short description about the contents of the publication. Additionally, visual elements, such indicators 420 and 430 can provide information regarding the references cited by the currently displayed publication, and the references which cite to it, respectively. As with the initial display of the selected search result within the details area 240, described above, the display of a selected publication within the details area 240 need not conform precisely to the example illustrated in FIG. 5 and can instead provide similar information through a different visual presentation, including, for example, a more broad citation map image, with areas beyond the information previously downloaded remaining shaded.

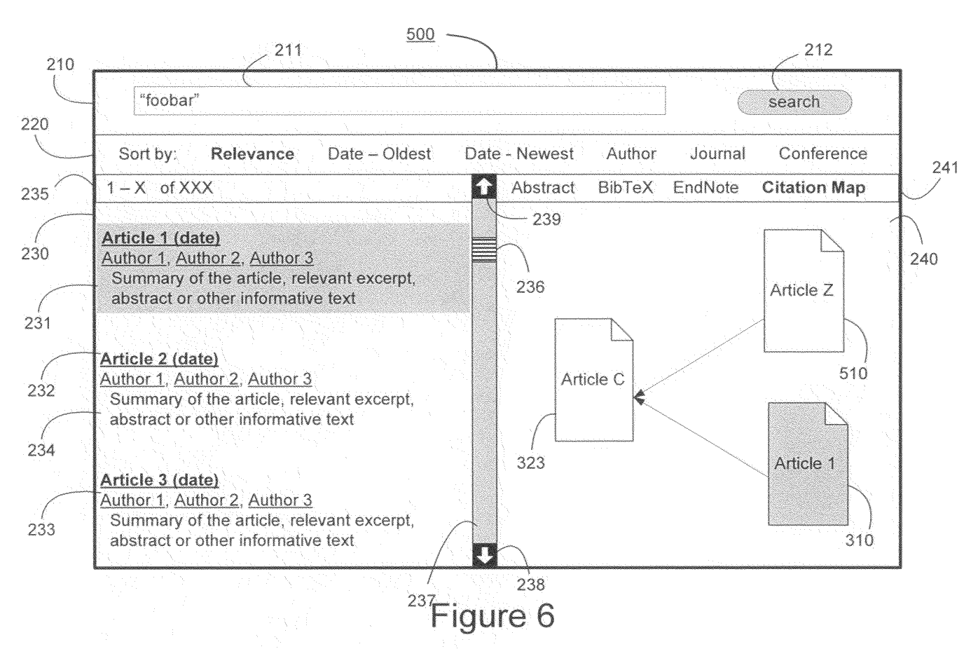

A user can proceed to interact with the presentation of citation map information by selecting one of the indicators 420 or 430, and thereby further exploring the publications associated with the originally selected search result. For example, if the user were to select indicator 430, a display of the publications which cite the publication represented by icon 410 can be shown in the details area 240. The exemplary web page display 500 of FIG. 6 illustrates such a presentation according to one embodiment. Specifically, as shown in the exemplary web page display 500 of FIG. 6, the icon 323, representing the previously selected publication, can be shown with referencing arrows to the publications which cite to it. As indicated previously, one such publication can be the originally selected search result, represented, as before, with icon 310. The other publication which cites to the previously selected publication can be a previously undisplayed publication, represented by icon 510. Thus, by interacting with the citation map to explore the referencing relationships between publications, the user can learn of related publications that may not have been presented to the user through a more traditional textual query.

The interactions described above with respect to FIGS. 3 through 6 can be repeated as desired by the user. Thus, for example, the user could explore the publications cited by the publication represented by icon 510, and the publications citing to it, by following similar steps to those described in detail above with respect to the publication represented by icon 323 and with respect to the publication represented by icon 310, which was the originally selected search result. In such a manner, the user can explore the interrelationships among publications based on the citations to other publications.

The examples shown in FIG. 3 through 6, however, are merely meant to be illustrative, and are not intended to represent a required user interface. Indeed, any user interface that can meaningfully enable user interaction with a layout of publications illustrating referencing links can be presented in the details area 240 if the user selects the citation map option in the details selection 241. For example, rather than displaying a selected publication by itself each time a new publication is selected by the user, in an alternative embodiment the newly selected publication can be integrated into the previously selected, and displayed, publications, thereby enabling the user to visually recall their prior selection. A user's prior selections can likewise be visualized though shading or coloring, such as by changing the color of the text presented by an icon representing a previously selected publication.

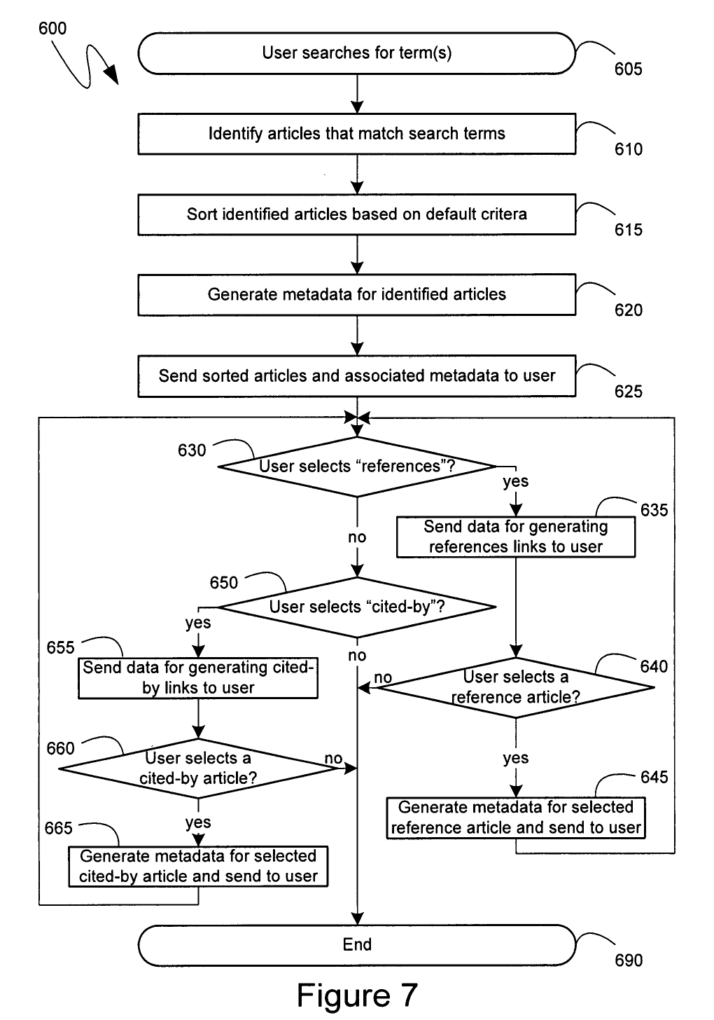

Turning to FIG. 7, a flowchart 600 is shown focusing on the operations that can support the presentation of the visual interfaces shown in FIGS. 3 through 6. Initially, as indicated by step 605, a user can search of a term, or collection of terms, for which the user seeks to find relevant publications, such as publications containing those search terms. In response to the user's search at step 605, articles and other publications matching those search terms can be identified at step 610. To provide a more meaningful presentation of the publications identified at step 610, a sorting can be applied at step 615.

Prior to sending the sorted publications that have been determined to be relevant to the user's search terms, metadata regarding each of the publication can be generated at step 620. In one embodiment, the metadata of a publication can include information regarding other publications cited by that publication, and information regarding the citation of that publication by other publications. Such metadata can be used in the manner described in detail above to generate a citation map.

Once the sorted publications and associated metadata have been obtained, they can be sent to the user at step 625. Such a transmission can, in one embodiment, comprise the transmission of HTML-formatted data to a browser 11 being controlled by the user. The browser 11 can receive the HTML-formatted data and can display the search results and interfaces in the manner described in detail above, and illustrated by FIGS. 3 through 6. Specifically, if the user has selected the citation map option in the details selection 241, then the details area 240 can comprise, for a selected search result, indicators regarding publications that are referenced by the selected search result, and indicators regarding publications that reference the selected search result. At step 630, if the user selects the indicator regarding publications that are referenced by a selected publication, then, at step 635, data regarding those publications, including their link to the selected publication, can be sent to the user. Subsequently, at step 640, it can be determined if the user selects one of those cited publications, such as, for example, based on the data received at step 635. If the user does select one of those publications, then additional metadata for the newly selected publication can be generated at sent to the user at step 645 to, for example, enable the display of such information in the details area 240. Processing can then return to the decision at step 630. If the user did not select any publication from among the publications referenced by the selected search result, then the processing can end at step 690, as indicated.

If, at step 630, it is determined that the user has not selected to receive and display further information regarding the publications cited by the selected publication, a subsequent decision at step 650 can determine if the user has selected to receive and display information regarding the publications that cite to the selected publication. If the user has so selected, then, at step 655, data regarding the publications that cite to the selected publication, including their link to the selected publication can be sent to the user. Subsequently, at step 660, a determination can be made regarding the user's further selection of one of the publications that cites to the selected publication. If the user has not made such a selection, the processing can end at step 690. However, if the user does select a new publication, the metadata for that publication can be generated and sent to the user at step 665. Processing can then return to step 630 to wait for potential user interaction with the information displayed in the details area 240. If the user selects neither to receive additional information regarding the publications cited by the currently selected publication at step 630, nor does the user select to receive additional information regarding the publications which cite to the currently selected publication at step 650, then the processing can end at step 690.

As can be seen from the above descriptions, mechanisms for enabling a user to navigate around a citation map are presented, where the citation map represents a visual presentation of the interrelationships between a selected publication and the publications which cite to it, and the ones which are cited to by the selected publication. In view of the many possible variations of the subject matter described herein, we claim as our invention all such embodiments as may come within the scope of the following claims and equivalents thereto.

We claim:

1. One or more computer-readable media comprising computer-executable instructions for instructing a browser to display search results, the computer-executable instructions directed to steps comprising:
instructing the browser to generate at least a primary and a secondary display areas;
instructing the browser to display, in the primary display area, search results received from a search engine; and
instructing the browser to display, in the secondary display area, a citation map of a selected search result from among the search results, the citation map comprising a visualization of citation metadata for the selected search result received concurrently with the search results.

2. The computer-readable media of claim 1, wherein the visualization of the citation metadata comprises a first indication of publications which are referenced by the selected search result, and a second indication of publications which cite to the selected search result.

3. The computer-readable media of claim 1 comprising further computer-executable instructions directed to instructing the browser to update, in response to interaction with the citation map, the secondary display area only.

4. The computer-readable media of claim 1, wherein the citation map further comprises a visual representation of publications referenced by the selected search result, a visual representation of publications which cite to the selected search result, and linking indicators between the visual representation of publications referenced by the selected search result and a visual representation of the selected search result, and between the visual representation of the selected search result and the visual representation of publications which cite to the selected search result.

5. The computer-readable media of claim 4, wherein the visual representation of publications referenced by the selected search result and the visual representation of publications which cite to the selected search result are arranged in chronological order.

6. The computer-readable media of claim 1 comprising further computer-executable instructions directed to instructing the browser to display a zoom control for defining the scope of the citation metadata visualized by the citation map.

7. The computer-readable media of claim 1 comprising further computer-executable instructions directed to instructing the browser to cache visualizations of the citation metadata beyond that displayed in the secondary display area and instructing the browser to enable scrolling for changing the secondary display area to include at least one of the cached visualizations.

8. One or more computer-readable media comprising computer-executable instructions for providing search results, the computer-executable instructions directed to steps comprising:
receiving a search request comprising at least one search term;
identifying one or more search results relevant to the at least one search term;
generating associated metadata regarding each of the one or more search results, the metadata comprising identification of publications which are referenced by the selected search result and publications which cite to the selected search result;
transmitting the one or more search results and the associated metadata; and
transmitting instructions to display a citation map of a selected search result from among the search results, the citation map comprising a visualization of the associated metadata for the selected search result.

9. The computer-readable media of claim 8 comprising further computer-executable instructions directed to generating the citation map.

10. The computer-readable media of claim 8, wherein the citation map further comprises linking indicators between a visual representation of the publications which are referenced by the selected search result and a visual representation of the selected search result, and between the visual representation of the selected search result and a visual representation of publications which cite to the selected search result.

11. The computer-readable media of claim 8, wherein the visual representation of publications referenced by the selected search result and the visual representation of publications which cite to the selected search result are arranged in chronological order.

12. The computer-readable media of claim 8 comprising further computer-executable instructions directed to steps comprising: receiving a request for citation information for a selected publication; identifying referenced publications which are referenced by the selected publication and citing to publications which cite to the selected publication; and transmitting information regarding the referenced publications and the citing to publications.

13. A user interface comprising:
a search term input area for receiving one or more search terms;
a primary and a secondary display area;
a listing, in the primary area, of one or more publications relevant to the one or more search terms; and
a citation map, in the secondary display area, initially centered on a selected publication from the listing of the one or more publications in the primary area, the citation map comprising an indication of publications which are referenced by the selected publication, and an indication of publications which cite to the selected publication.

14. The user interface of claim 13, wherein the primary display area is independent of user input in the secondary display area.

15. The user interface of claim 13 further comprising a zoom control in the secondary display area for defining the scope of the citation map displayed in the secondary display area.

16. The user interface of claim 13, wherein the indication of publications which are referenced by the selected publication comprises a visual representation of publications referenced by the selected publication and linking indicators between the visual representation of publications referenced by the selected publication and a visual representation of the selected publication; and wherein further the indication of publications which cite to the selected publication comprises a visual representation of publications which cite to the publication and linking indicators between the visual representation of the selected publication and the visual representation of publications which cite to the selected publication.

17. The user interface of claim 16, wherein selection of a visual representation from among the visual representation of publications referenced by the selected publication or from among the visual representation of publications which cite to the selected publication causes the display, in the secondary display area, of an indication of publications which are referenced by a publication represented by the selected visual representation, and an indication of publications which cite to the publication represented by the selected visual representation.

18. The user interface of claim 16, wherein the visual representation of publications referenced by the selected publication and the visual representation of publications which cite to the selected publication are arranged in chronological order.

19. The user interface of claim 16, wherein the visual representation of publications referenced by the selected publication and the visual representation of publications which cite to the selected publication indicate whether they have previously been selected.

20. The user interface of claim 16, wherein user action directed to either the visual representation of the selected publication, the visual representation of publications referenced by the selected publication, or the visual representation of publications which cite to the selected publication causes the display, in another user interface element, of further publication-centric information.
